(19) United States
(12) Patent Application Publication
(10) Pub. No.: US 2008/0204437 A1
(43) Pub. Date: Aug. 28, 2008

(54) Light-sensor-placement device for color display, and displays comprising same

(75) Inventor: Luhr Jensen, Tigard, OR (US)

Correspondence Address: KLARQUIST SPARKMAN, LLP, 121 SW SALMON STREET, SUITE 1600, PORTLAND, OR, 97204, US

(73) Assignee: Klein Optical Instuments, Inc.

(21) Appl. No.: 11/711,205

(22) Filed: Feb. 26, 2007

(51) Int. Cl. G09G 5/00

(52) U.S. Cl. 345/207

(57) ABSTRACT

Light-sensor devices are disclosed for use with a color display such as a CRT, LCD, plasma display, or other type of display. The device includes an arm having a proximal end and a distal end, wherein a light sensor is situated on or near the distal end. A mover, coupled to or near the proximal end, is configured to move the arm to place the sensor selectively at a parked position and at a measurement position. The mover can be electrically energizable to cause motion of the arm. The mover can be or include a motor. Such a light-sensor device can be mounted to a display and thus become a substantially permanent part of the display and can be used with displays that are difficult or inconvenient to keep color-calibrated, or are difficult or impossible to reach for color-calibration.

### FIELD

This disclosure is directed to, inter alia, devices for holding and positioning (“placing”) a light sensor, used for sensing at least one color aspect of an image produced by a color display, in a measurement position relative to the display.

### BACKGROUND

Several types of color displays are currently used for television and related purposes, for display of information from a computer, for video games, and other image-display purposes. Exemplary color displays include cathode-ray tubes (CRTs), flat-panel plasma displays, flat-panel liquid-crystal displays (LCDs), digital light processing (DLP) displays, organic light-emitting diode (OLED) displays, and thin-film transistor (TFT) displays. Color displays are a rapidly changing area of technology, and it is expected that displays based on technologies other than these will make their debut in due course.

As are most electronic devices, color displays are subject to drift and the like, which can result in, among various possible faults, changes in color of the image produced by the display. For many years after their debut, color displays were simply left to drift out of color and intensity calibration for want of an easy way to bring them back into calibration. For example, anyone who has been a passenger on a commercial airliner providing in-flight movies displayed from multiple monitors throughout the passenger cabin has seen that no two monitors have the same color balance.

Color balance and fidelity are important aspects of displayed color images; e.g., flesh tones are especially affected by even small variations in color balance. The importance of these aspects has led to the development of colorimeters and the like for the specific task of measuring colors as produced by a display. Many uses of color displays require that exacting tolerances be held with respect to displayed color, both in new equipment and over time during use of the equipment. This has engendered industry standards against which the performance of display modules can be evaluated and calibrated. Because various types of displays operate on different principles and have different characteristics, specific respective types of sensors have been developed for sensing and/or measuring color-related aspects of these different types of displays.

Many types of sensors are simply placed (e.g., using a suction cup applied to the display) in front of a displayed image and provide a color and/or light-intensity measurement. The sensor should be placed to sense one or more colors being produced by the display. The color data can be used to adjust or calibrate the display. However, most users of displays are unaware that color measurements can be taken and/or that such adjustments or calibrations can be done. Even among users who are aware of color measurements, most are disinclined to perform them, largely because of the time and inconvenience required to perform them. This problem is especially prevalent in situations in which multiple displays are used and/or the displays are out of reach of the user.

An example of a “calorimeter” is discussed in U.S. Pat. Nos. 6,784,995 and 7,133,133 to Merle et al., incorporated herein by reference. The colorimeter is suspended from the top of the display onto the front (“screen,” or light-producing surface) of the display using a flexible string, ribbon, plastic strip, or rubber tubing. A disadvantage of suspending the colorimeter in this manner is that it is very difficult to place the colorimeter consistently and accurately at a specific location relative to the screen. It is also impossible to place the colorimeter consistently at the same distance from the screen. Another disadvantage is that placement and retraction of the colorimeter must be performed manually, which is difficult or impossible to do with displays that are not manually reachable, such as in newsrooms and other TV broadcast facilities in which a large number of displays are disposed out of reach of the personnel in the facility.

Another “calorimeter,” intended for performing color measurements of a flat-panel display, is discussed in U.S. Pat. No. 7,068,263, incorporated herein by reference. The colorimeter is mountable on a hangar that can only manually be placed relative to the display screen or removed from the display. Consequently, this colorimeter would not be used with a display that is out of reach.

Hence, there is a need for a light-sensor device that is mountable to or integral with a display and that is movable from a retracted, or “parked,” position to a measurement position and back again, in a manner allowing the display and light-sensor device to be situated out of reach of an operator or viewer during use of the light-sensor device. There is also a need for light-sensing devices that can be placed, for measurement purposes, accurately and precisely at a predetermined position relative to, including a predetermined distance from, the display easily and conveniently.

### SUMMARY

The needs articulated above are met by various embodiments, as disclosed herein, of sensor devices for detecting one or more color aspects of light produced by the display. Certain embodiments are configured to place a sensor accurately and precisely in a measurement position of a display, at which measurement position a color measurement of light produced by the display can be made. After completion of the measurement or during periods of non-use, the sensor is movable to a parked position. These placements and movements can be made with minimal action by the user, allowing the sensor devices to be used on displays that are out of reach.

According to a first aspect, sensor devices are provided for a color display. The color display is as discussed elsewhere herein. An embodiment of the subject sensor device comprises an arm, a sensor for detecting and/or sensing aspects of one or more colors produced by the display, and a mover. As discussed later below, the mover can encompass any of various devices configured to move and place the sensor in a desired location relative to the display. The arm has a proximal end and a distal end. The sensor is situated on the distal end. The mover is coupled to the proximal end and is configured to move the arm to place the sensor selectively at a parked position and at a measurement position.

As used herein, the “arm” can have any of various configurations such as, but not limited to, rods and other elongated members, paddles, and the like. The arm provides a way in which to hold the sensor at the measurement location while coupling the sensor at a location other than the measurement location or other location on the screen of the display. Thus, the arm holding the sensor at the measurement location extends over at least a region of the screen of the display. The mover can be actuated by any of various possible ways, including but not limited to electrical energization, hydraulically, pneumatically, mechanically, and manually. An example of electrical energization is achieved using an electrical motor such as a servo motor.

In many embodiments the measurement position is at least one predetermined location relative to the display's screen at which the light sensor receives light from the screen. The parked position desirably is a predetermined location at which the light sensor does not receive significant light from the screen.

If the display comprises a housing, the parked position can be in a region of the housing. For example, if the housing comprises a bezel, the parked position can be along the bezel. Alternatively or in addition, the parked position is at least partially within the bezel or on the bezel.

If the arm has a proximal end, the proximal end can comprise a pivot mounting coupled to the display. In this configuration the mover can be configured to pivot the arm about the pivot mounting to place the light sensor selectively at the parked position and at the measurement position.

In some embodiments the mover is configured to move the arm substantially in one dimension to place the light sensor selectively at the parked position and at the measurement position. The proximal end of the arm can be coupled to a slide, wherein the mover is configured to move the proximal end of the arm along the slide.

In other embodiments the mover is configured to move the arm substantially in at least two dimensions to place the light sensor selectively at the parked position and at the measurement position. The mover can be configured to move the arm by motions selected from the group consisting of pivoting, rotation, sliding, hinging, elongation, retraction, and combinations thereof.

In certain embodiments the arm is rigid in at least two dimensions. For example, the arm can be substantially rod-shaped or paddle-shaped, or have any of various other elongated configurations.

Other embodiments of a sensor device for a color display comprise an arm, a light sensor situated on the distal end of the arm, and a mounting coupled to the display and configured to couple at least the proximal end of the arm to the display. As noted above, the arm can have any of various elongated configurations. The arm in these embodiments is movable relative to the mounting to place the light sensor selectively at a parked position and at a measurement position of the display. The arm can be flexible in one or two dimensions. The device further can comprise a mover situated and configured to move the arm relative to the mounting. In some embodiments the mover comprises an electrically energizable actuator.

According to another aspect, methods are provided for performing a measurement of an aspect of colored light produced by a light-emitting screen of a display. An embodiment of such a method comprises mounting a light sensor on an arm, wherein the arm is movable relative to the display so as to place the sensor selectively at a parked position and at a measurement position of the display. The arm is actuated to place the sensor at the measurement position. Using the sensor, a color property of light being produced by the screen is measured at the measurement position. After obtaining the measurement, the arm is actuated to place the light sensor at the parked position.

The foregoing and additional features and advantages of the invention will be more readily apparent from the following detailed description, which proceeds with reference to the accompanying drawings.

### BRIEF DESCRIPTION OF THE DRAWINGS

FIG. 1 shows certain features of an exemplary display, in this instance a flat- panel display, with which various embodiments of the subject sensor device can be used.

FIG. 2 schematically depicts certain general features and relationships of components of various embodiments of the subject sensor device.

FIG. 3(A) is a front view of a display including a sensor device according to the first representative embodiment, in which the arm is configured to pivot from the parked position to the measurement position.

FIG. 3(B) is a partial side elevational view of the first representative embodiment, depicting the arm in the parked position.

FIG. 3(C) is a partial side elevational view of the first representative embodiment, depicting the arm in the measurement position.

FIG. 3(D) depicts certain details of an exemplary light-sensor chip and lens that can be used in the first representative embodiment.

FIG. 3(E) is a front view of a display including a sensor device according to an alternative configuration of the first representative embodiment.

FIG. 4 is a front view of a display including a sensor device according to the second representative embodiment, in which the arm is configured to pivot from the parked position to the measurement position.

FIG. 5 is a front view of a display including a sensor device according to the third representative embodiment, in which the arm is configured to slide from the parked position to the measurement position. In an alternative configuration, the arm is configured to hinge from the parked position to the measurement position.

FIG. 6 is a front view of a display including a sensor device according to an alternative embodiment, in which a light sensor is situated on the distal end of a flexible tape- or ribbon-like arm configured to move out and down in the figure from the parked position to the measurement position.

FIG. 7 is a front view of a display including a sensor device according to another alternative embodiment, in which the light sensor is situated on the distal end of a scissors-type arm.

FIG. 8 is a front view of a display including a sensor device according to yet another alternative embodiment, in which the light sensor is configured to slide laterally from the parked position to the measurement position.

### DETAILED DESCRIPTION

The invention is described below in the context of representative embodiments that are not intended to be limiting in any way.

In the following description, certain terms may be used such as “up,” “down,”, “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

In general, the subject devices are configured to move and hold a “light sensor” relative to a color display for obtaining a measurement of at least one color being produced by the display and to move the light sensor away from the display when color measurement is not being performed. The term “light sensor” generally encompasses any of various current “calorimeters” and color-sensors as used for performing color measurements (intensity and/or wavelength) of light produced by a color display. The colorimeters usually comprise at least one photodiode or phototransistor and at least one color filter as required. For example, some comprise a separate photodiode and filter for each of the three primary colors (R, B, G). Multiple configurations of sensors based on this general concept are currently available, and many of these are well miniaturized and inexpensive. The term “light sensor” also encompasses other devices such as (but not limited to) a graded-wavelength interference filter over a multi-element sensor, and a spectroradiometer utilizing an interference grating and multi-element sensor. It is expected that other types of sensors will be developed and miniaturized sufficiently (with attendant reductions in cost) for advantageous use as a sensor in any of various embodiments within the scope of this disclosure.

For performing a measurement, the light sensor is normally placed adjacent (not necessarily immediately adjacent) the “illuminated” (image-producing) surface (called a “screen”) of the display so as to receive image light from the display. Data obtained by the sensor can be used for performing intensity and/or color adjustments and/or calibrations of the display, either manually or automatically.

### General Considerations

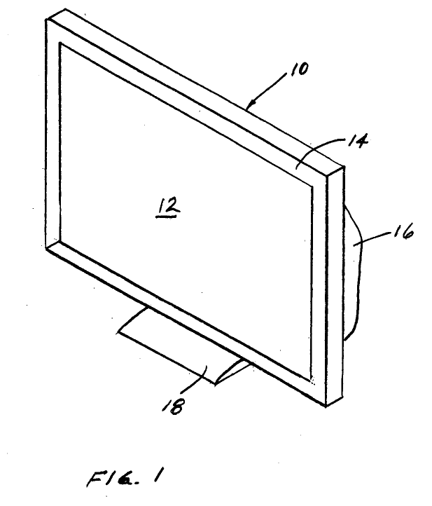

A typical “display,” such as the display 10 shown in FIG. 1, comprises what is conventionally termed a “screen” 12, a “bezel” 14 or the like in circumferential relationship to the screen, a housing 16 (of which the bezel is usually considered a part), and a stand 18 or other appropriate mounting. The housing 16 typically contains delicate portions of the screen and at least some electronics for causing the screen to produce light and display images. By way of example, and not intending to be limiting, the display 10 can be a liquid-crystal display (LCD), a plasma display, a cathode-ray tube (CRT), a digital light processing (DLP) display, an organic light-emitting diode (OLED) display, a thin-film transistor (TFT) display, or analogous device including displays based on future display technologies. The LCDs and plasma displays are examples of “flat-panel” displays, in contrast to the substantially more boxy CRTs. The display 10 can be, for example (and not intending to be limiting in any way), a computer display, a television monitor, a video-game display, a control display connected to a process machine (e.g., medical machine or CNC milling machine), or a “touch” screen. Since color sensors are normally used with “color” displays, it will be understood that the “display” as referred to herein is generally a color display (displaying color(s) other than only conventional “black” and “white”). In this regard it will also be understood that the display 10 need not be a full-color display. For example, the display 10 may be configured to provide images containing only certain colors, even as few as only one color, but wherein it is important or desirable to be able to measure the color(s) for calibration or adjustment purposes or the like.

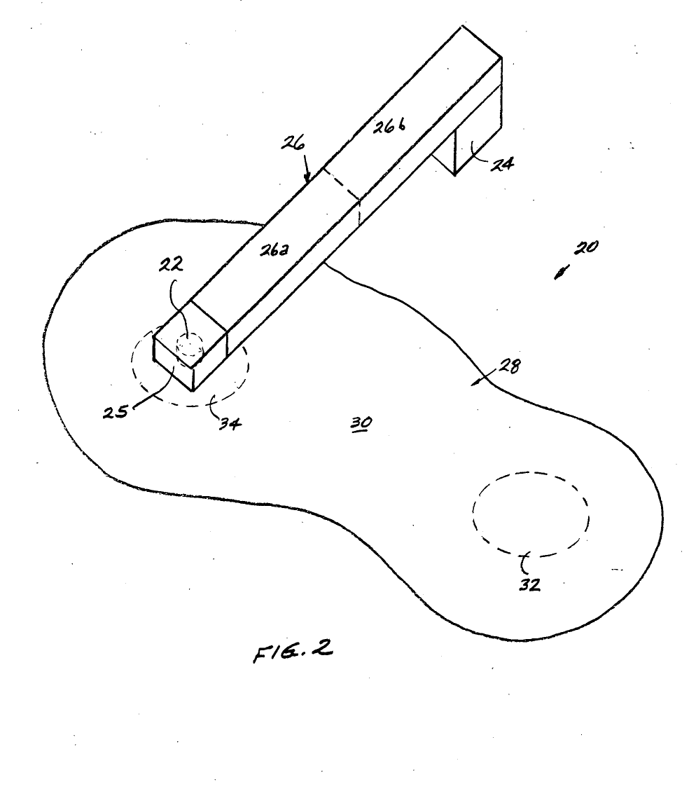

Certain general aspects of various embodiments of a sensor device are depicted schematically in FIG. 2. The depicted sensor device 20 comprises a light sensor 22, a mover 24, and an arm 26 connecting the mover to the light sensor. Also shown is an area 30 representing a portion of a display 28. The depicted area 30 includes two locations 32, 34. The location 32 is a region on the screen at which location a color measurement is intended to be performed. With some displays, the location 32 may be one that is specially selected for measurement purposes. The location 32 can be regarded as corresponding to a “measurement” position of the light sensor 22, at which the sensor is situated for performing a color measurement (intensity and/or wavelength) of light from the display 28. The location 34 can be another location on the screen, a location off the screen such as on or in the bezel of the display 28, or even a location in space displaced from the housing of the display. The location 34 can be regarded as corresponding to a “parked” position of the light sensor 22, at which the light sensor desirably is situated whenever it is not performing a color measurement of the display. The parked location 34 desirably is outside the propagation path of light from the display 28 to prevent the light sensor 22 at the parked location 34 from significantly interfering with or obstructing the image being produced by display 28.

At the measurement location 32 the light sensor 22 is not necessarily contacting the screen, although it can be if required or desired (and technically permissible with the particular type of display). Certain types of light sensors are configured to contact the screen (usually very lightly), and other types of sensors are configured to operate while displaced a defined distance from the screen. With some displays, this distance can be important for obtaining proper color measurements. At the parked location 34, the light sensor 22 is not necessarily contacting any portion of the display.

Moving the light sensor 22 from the parked location 34 to the measurement location 32 is achieved by the mover 24 controllably moving the arm 26 (and thus the sensor 22) relative to the display. The arm 26 is sufficiently rigid so that, upon positioning the light sensor 22 at the desired location 32, 34, the sensor remains at that location unless and until the mover 24 causes the arm to move the sensor to the other position. In various specific embodiments the arm 26 moves the sensor 22 in various respective manners, including a pivotal manner, a linear-motion (sliding) manner, a two- or three-dimensional-motion manner, a telescoping manner, a hinged manner, a combination of any of these manners, or in any other analogous manner within the scope of modern machine design. In any event, the arm 26 desirably is configured so that the light sensor 22, when moved by the arm to the measurement location 32, is positioned at substantially the same location each time relative to the screen.

The arm 26 can be a single unit or can be multiple units 26a, 26b providing the arm with sufficient articulation as required to perform controlled bending of the arm, extension and contraction of the arm, and the like, according to particular embodiments. For example, the units 26a, 26b can be respective portions of an articulated, segmented, scissors, or telescoping configuration by which the length of the arm 26 can change.

In many embodiments the mover 24 comprises any of various types of energizable actuators including, but not limited to, rotary motors, other rotary actuators, linear motors, pneumatic actuators, and solenoids. Most of these actuators are available in appropriately miniaturized configurations for advantageous use in the various embodiments. For example, a large number of miniaturized rotary motors are available for use in mini-robotics, cameras, computer hard-drives, and the like. Exemplary motors in this regard include, but are not limited to, servo motors, synchro motors, stepper motors, brushless motors, and brushed motors. In other embodiments the mover 24 is any of various manual actuators such as a lever or the like that is manipulated by hand (manually). In either event, the sensor device 20 can include at least one stop, detent, latch, over-center mechanism, electrical switch (e.g., momentary contact switch or optical switch), motor-current detector, or analogous means for stopping movement of the arm 26 and ensuring accurate and precise placement of the sensor 22 at least at the measurement location 32.

The mover 24 can be mounted at any of various locations on or in the bezel 14 or housing 16 of the display. In certain embodiments the mover 24 is situated in its own housing that can be attached to the display, e.g., along the edge of the bezel or housing. An example of this configuration is a sensor device that is self-contained and that is attachable as a unit to any of various displays. In other embodiments the mover 24 is mounted inside the bezel 14, with the arm 26 being located outside the bezel. An example of this other configuration is a sensor device that is integral with the display and that is normally provided built-in to the display.

The mover 24 can include, if necessary or desired, an encoder or analogous means for measuring the extent of actuation or motion of the mover, thereby providing data on the position of the light sensor 22 achieved by the mover. Such data is advantageous if the mover 24 is connected for feed-back control. For example, a rotary motor can include a rotary encoder, and a linear motor can include a linear encoder. In a more specific example, certain miniature servo motors include logic chips and gearing sufficient to rotate a variable resistor to detect rotary position. With stepper motors, although they tend to be costly, position can be determined simply by counting pulses. In other embodiments, the mover 24 (e.g., a pneumatic actuator) can be configured (e.g., with mechanical “stops”, electrical limit switches, or the like) to place, consistently and reliably, the sensor 22 at substantially the same measurement location 32 every time.

As noted, the parked location 34 can be another location on the screen, a location off the screen such as on or in the bezel of the display 28, or even a location in space displaced from the housing of the display. In general, the parked location 34 is a location at which the light sensor 22 is not making a color measurement of the display 28 or at least a location at which the sensor (and arm 26) are not obstructing viewing of an image produced by the display. For example, in certain embodiments the arm 26 and light sensor 22 at the parked location 34 are nested onto the bezel of the display 28 so as to appear contiguous with the bezel. In these and other embodiments, the parked location 34 can be at the top, at the bottom, or along a side of the bezel. In other embodiments, the parked arm 26 and sensor 22 are retracted into a slot, recess, pocket, or the like in the bezel or housing of the display 28. The particular manner of positioning, containing, and/or configuring the arm 26 and sensor 22 in the parked position can be selected based on aesthetic appearance, convenience, safety, practicality, physical accommodation, cost, and/or other applicable factors.

The light sensor 22 can be any of various types. Some types of sensors are configured as “calorimeters” that include one or more photodiodes (e.g., one for each of red, green, and blue light), and optionally color filters for color discrimination. In one exemplary embodiment, the sensor 22 detects at least one color wavelength, or at least an aspect of the wavelength, produced by the display. The sensor in this embodiment also includes a lens or other light-conditioning device that gathers light collected at the measurement location 32 and that shapes the light as appropriate for being received by the sensor, and electronics for energizing the sensor and for processing data from the sensor. The sensor can comprise a light-to-frequency converter, which may have red (R), green (G), and blue (B) filters associated with it. The sensor can comprise a single light-gathering chip or alternatively multiple colored-light-gathering chips (e.g., one for each of R, G, and B). The lens not only collects light from the measurement location 32 but also can be used to define or limit the angular input of light entering the sensor from the display, as required. The sensor may also include a light-restricting baffle, cone, or the like that limits incursion of unwanted light, such as ambient light.

In FIG. 2 the light sensor 22 is situated in a housing 25 that conforms to the distal end 26a of the arm 26. Alternatively, the housing 25 can be integral with the arm 26. Further alternatively, rather than being coupled directly to the arm 26, the housing 25 (having any of various shapes) can be mounted in a holder attached to the distal end 26a of the arm. Such a holder can have any of various configurations, including but not limited to, clips, holster, cradle, bracket, mounting plate, mounting member, and the like that would provide secure attachment of the sensor 22 to the arm 26.

### First Representative Embodiment

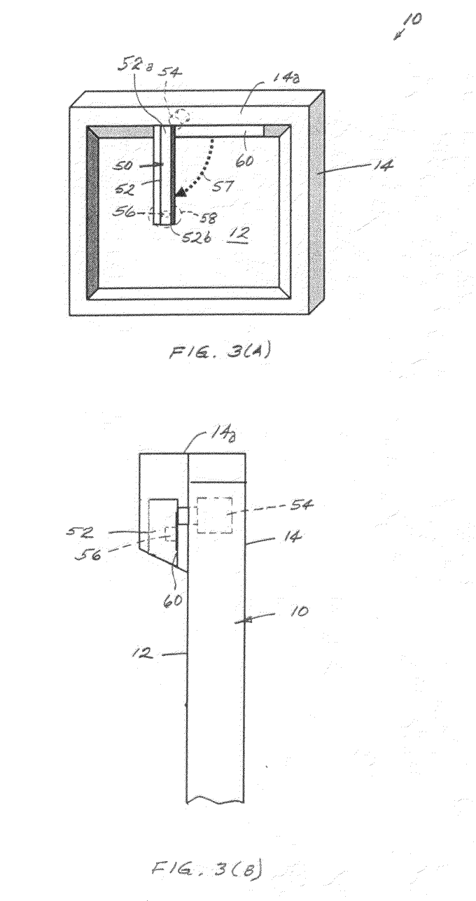

This embodiment is depicted in FIGS. 3(A)-3(C). Referring first to FIG. 3(A), a display 10 is shown. The display 10 comprises a screen 12 and a bezel 14 having a top portion 14a. Associated with the display 10 is a sensor device 50 that, from a practical standpoint, is substantially permanently mounted to the display. The sensor device 50 comprises a rigid arm 52 having a proximal end 52a and a distal end 52b. The proximal end 52a is coupled to a motor 54, as an exemplary mover. Attached to the distal end 52b is a light sensor 56. The arm 52 is pivotable about its proximal end 52a to place (arrow 57) the sensor 56 selectively at a measurement position 58, as shown, and at a parked position 60. Electronics for the sensor 56 can be incorporated on a circuit board or flexible circuit (not detailed, but see FIG. 3(D), for example) mounted inside the arm 52; the board or flex-circuit can be coextensive with the arm if necessary or desired. The motor 54 can be located under the bezel 14 in the front of the display 10, as shown in FIGS. 3(B) and 3(C), or on the edge of the bezel. The actual position and alignment of the sensor 56 in the measurement position 58 are determined by the arm 52 and motor 54. The measurement position 58 can be located at the center of the screen 12 or at any other location relative to a “quality area” of the screen, wherein “quality area”—is the area of the screen producing any portion of the usable (viewable) image.

In this embodiment the arm 52 has a surface profile that conforms to the contour of the bezel 14. Thus, whenever the arm is in the parked position 60, the arm continues, and thus blends into, the contour of the bezel 14. FIG. 3(B) depicts the arm 52 and sensor 56 in the parked position 60, in which the sensor 56 is nested to the bezel 14 and thus is sequestered away from the screen 12. Although this figure depicts the parked position 60 as being associated with the upper portion 14a of the bezel 14, the parked position alternatively can be located on the bottom portion or on a side portion of the bezel. FIG. 3(C) depicts the arm 52 and sensor 56 in the measurement position 58.

The motor 54 in this embodiment is a rotary motor configured to undergo limited rotation. Typically, a motor 54 of this type comprises a rotary member (armature) that rotates, when the motor is energized, relative to a stationary portion (e.g., stator). The arm 52 can be coupled directly to the armature. An exemplary motor that can be used in this manner is a servo motor. (Inexpensive servo motors are available for use in mini-robotics; the motors include built-in variable resistors and processing electronics for determining the angular position of the armature.) Alternatively, the arm 52 can be coupled indirectly to the rotary member 52. Examples of indirect coupling are gear trains, belts and pulleys, screw drives, and the like. Thus, rotation of the motor armature causes the arm 52 to pivot relative to the display 10 to place the sensor 56 at the measurement position 58 or at the parked position 60.

The motor 54 and arm 52 are configured such that, whenever the sensor 56 is at the measurement position 58, the arm 52 is sufficiently rigid and otherwise mechanically sound to provide high accuracy and precision of placement of the sensor 56 at that location. To such end, the sensor device 50 can include one or more “end-of-travel” devices such as mechanical stops, momentary-contact switches, limit switches, electrical-contact pins, or optical switches (interrupted light-beam switches comprising a packaged LED and detector with gap). A mechanical stop can be used with a motor-current detector that detects when the motor has stalled while urging the arm against the stop, for example. Any of these end-of-travel devices can be used to achieve feed-back control of the motor. Feed-back control also can be used with any device that detects rotation of the motor. While desirable for both locations 58, 60, high accuracy and precision of sensor placement is usually required only for the measurement position 58, not the parked position 60. Usually, less stringent placement requirements are posed by the parked position 60, compared to the measurement position 58.

The motor 54 and arm 52 can be configured selectively to place the sensor 56 controllably at any of multiple measurement locations rather than or in addition to only one measurement location 58. These measurement locations can be pre-selected or pre-determined.

An exemplary sensor 56 for this embodiment is shown in FIG. 3(D), which depicts the distal end 52b of the arm 52. Visible are the sensor chip 62, a lens 64, and a portion of a circuit board 66. The sensor chip 62 and lens 64 are situated in a recess in the distal end 52b. Light of one or more colors (or corresponding to one or more colors) from the measurement location 58 on the display is transmitted through and converged by the lens 64 onto the sensor chip 62. Electronics (not detailed) on the circuit board 66 energize the sensor chip 62 and process the signal from the sensor chip. Desirably, the surface of the distal end 52b facing the display has a black or otherwise non-reflective coating.

In an alternative configuration, shown in FIG. 3(E), the arm 52 in the parked position 60 is fully retracted into a slot or pocket 14c in the bezel 14. Thus, the arm 52 in this alternative embodiment does not conform to the outer contour of the bezel 14 when the arm is in the parked position 60. Having the parked position 60 be located within the bezel 14 or other part of the housing of the display, such as in the depicted manner, is desirable especially from the standpoint of preventing damage to, soiling of, or other trauma to the arm 52 and sensor 56 when not in use.

### Second Representative Embodiment

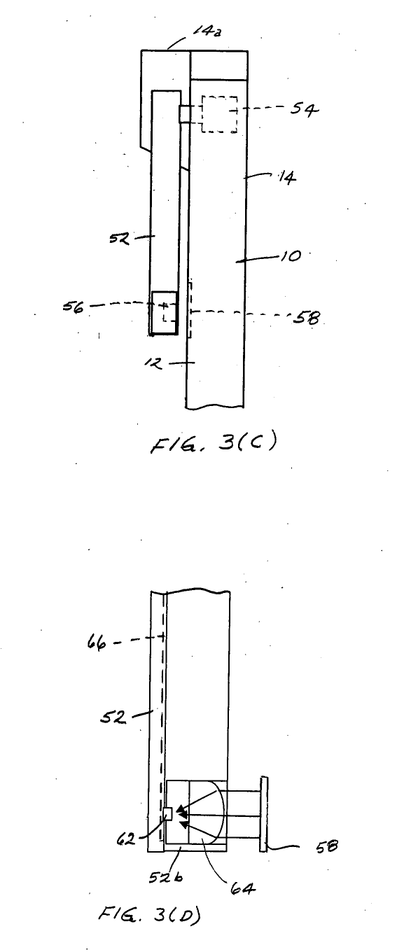

This embodiment is shown in FIG. 4, which depicts a display 10 with a screen 12 and bezel 14. The sensor device 70 is similar in many ways to the sensor device 50 of the first representative embodiment, except that the arm 72 in the instant embodiment does not conform to the contour of the bezel 14 when the sensor 76 is in the parked position 77. Rather, the arm 72 can be, for example, a simple tubular or planar (e.g., paddle-like) profile. Also, in this embodiment the motor 74 or other mover is located outside the bezel 14 rather than inside the bezel. FIG. 4 depicts the arm 72 in the measurement position 78. When the arm 72 is in the parked position 77, the arm is simply arranged horizontally, forwardly of the bezel 14.

This embodiment provides an example configuration of a sensor device 70 that can be attached, as a unit, to an existing display that otherwise lacks a sensor device. To such end, the motor 74 can be simply attached to the bezel 14, to the display housing, or to a frame in or coupled to the display, at any desired location that still allows movement of the arm 72 and placement of the sensor 76 for obtaining measurements of display color and/or intensity. The sensor device 70 can be “permanently mounted” to the display at time of manufacture of the display, or can be provided separately and mounted to an existing display.

### Third Representative Embodiment

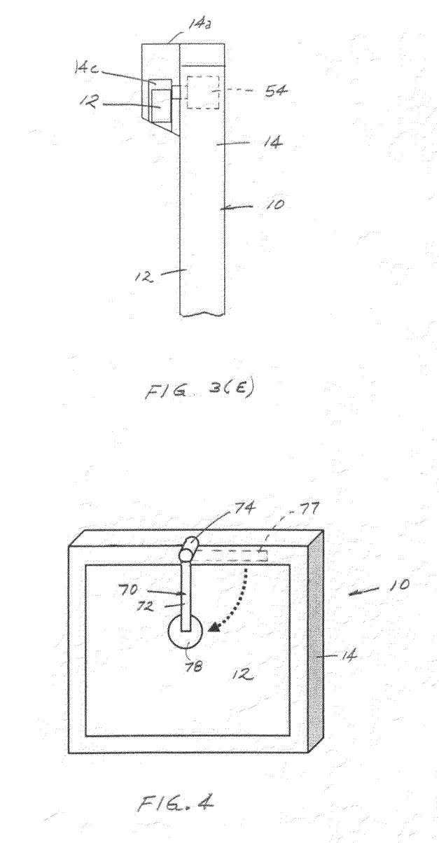

This embodiment is shown in FIG. 5, which depicts the display 10 comprising a screen 12 and a bezel 14 having a top portion 14a. Associated with the display 10 is a sensor device 80. The sensor device 80 comprises an arm 82 (having a paddle-like configuration in the figure). The arm 82 has a proximal end 82a and a distal end 82b, and a light sensor 86 is mounted on the distal end 82b. In the depicted configuration the arm 82 is slidable (up and down, arrow 83) between a measurement position 88 and a parked position 90. To move from the parked position 90 to the measurement position 88, the arm 82 is actuated to slide downward, in the figure. At the measurement position 88 the sensor 86, facing the screen 12, is positioned to receive light from the screen. To move from the measurement position 88 to the parked position 90, the arm 82 slides upward into a receptacle that, in the figure, is defined in or on the top portion 14a of the bezel.

The sliding motion of the arm 82 can be achieved by any of various movers, combined with an appropriate linkage, if required. Examples include rotary motors with rack and pinion gears, belt and pulley linkages, lead screws, and the like; linear pneumatic actuators; and linear solenoid actuators. Linkages such as gears, lead screws, and like desirably are selected or configured to have very low to substantially zero back-lash. Alternatively to use of these mechanisms, the sliding motion of the arm may be achieved manually.

In an alternative configuration, instead of the arm 82 being configured for sliding, the arm can be hinged. For example, referring in general to FIG. 5, the lower edge 82c of the arm can comprise a hinge coupled to the bezel 14 such that, as the arm is moving from the parked position to the measurement position, the arm pivots about its lower edge 82c downward in the manner of turning a page in a book. This pivoting motion can be achieved using a mover, such as any of various rotary actuators, or manually.

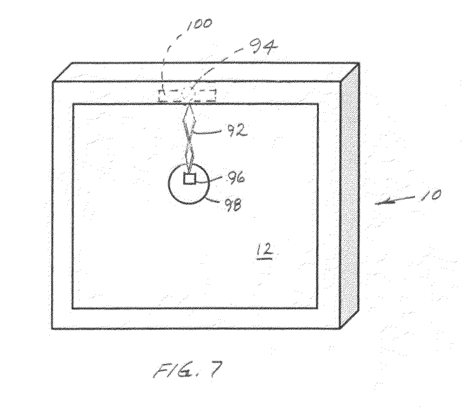

In yet another alternative configuration (FIG. 7), the sensor 96 is mounted on one end of a scissors linkage 92 (e.g., <XX> linkage), and the other end of the scissors linkage is coupled to a mover 94. In a conventional manner the mover 94 manipulates the scissors linkage 92 so as to cause the linkage to retract when moving the sensor 96 from the measurement position 98 to the parked position 100, and to cause the linkage to extend when moving the sensor from the parked position to the measurement position. As an alternative to using an actuated mover 94, the scissors linkage 92 can be moved and positioned manually.

### Other Exemplary Alternative Configurations

As noted, the retracted location can be outside the display housing or inside the display housing (e.g., under or inside the bezel of the display). In addition or alternatively, the retracted location can be in its own housing.

As noted, the mover can be outside the display housing or inside the display housing (e.g., under or inside the bezel). In addition or alternatively, the mover can be in its own housing that is attached to the display housing or to a frame holding the display, for example. This mover housing can also include at least a portion of the electronics used for driving an actuator in the mover or and/or for processing data obtained by the sensor.

The arm can be located completely outside the display housing. Alternatively, the arm can be located at least partially inside the display housing, at part of the time (such as when the arm is in the parked position). The arm can have its own housing.

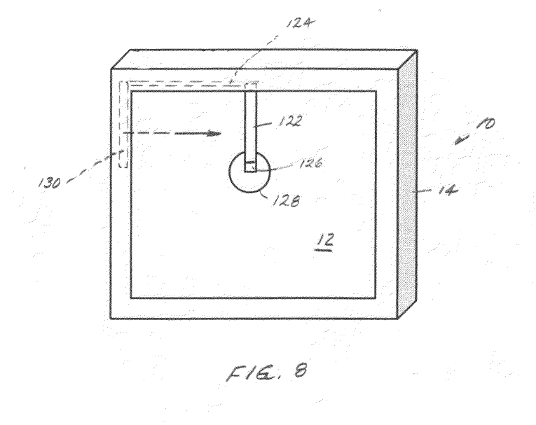

In the representative embodiments the arm pivots as it moves the sensor from the parked position to the measurement position and back again. Such pivoting motion is exemplary of two-dimensional motion of the arm. In alternative embodiments the arm slides laterally or vertically in one dimension such as the x-direction, y-direction, or z-direction. An example of such a configuration is shown in FIG. 8, in which the arm is mounted to a slide 124 or the like and is coupled to a mover (not detailed) configured to impart motion of the arm along the slide. In the figure, the slide 124 extends horizontally, but it will be understood that it alternatively can be vertical. The arm 122 moved completely, on the slide 124, to the left in the figure is in a parked position 130. Motion of the arm 122 completely to the right in the figure places the sensor 126 in a measurement position 128. From FIGS. 4, 6, and 8, for example, it will be understood that the arm can be mounted and actuated to move in three dimensions (x, y, and z) by an appropriate combination of single-dimension motions.

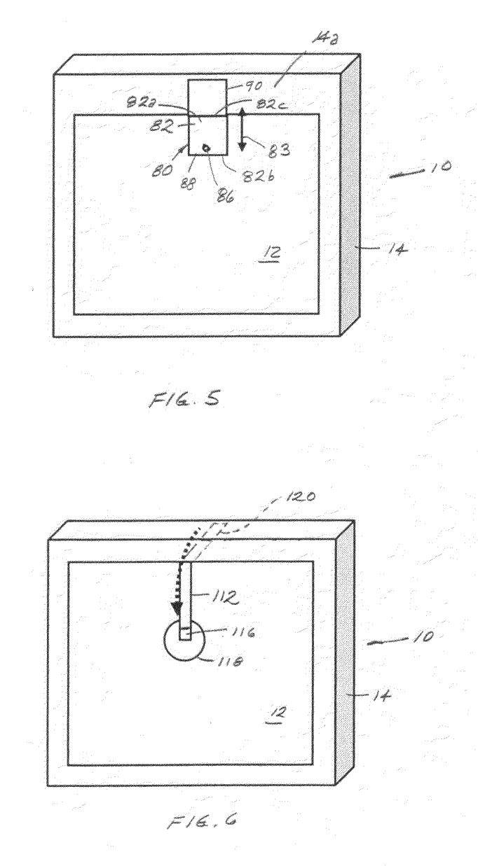

In the representative embodiments the arm is rigid, as achieved by configuring the arm as a rod or other elongated member, a paddle, or the like. In certain alternative embodiments, the arm comprises one or more wires configured and attached to each other so as collectively to form an arm having a desired amount of rigidity. In other alternative embodiments, the arm has a limited degree of flexibility (e.g., in one or two dimensions, without being stretchable) and is coupled to an actuator or other mover. As shown in the example of FIG. 6, the arm 112 can comprise a flexible band or cable that is bendable in one direction (e.g., y-direction) but not in the x-direction or z-direction. In another example the arm is bendable in the x- and y-directions but not in the z-direction. A mover (not detailed) for such a relatively flexible arm can comprise, for example, a motor fitted with a pulley or the like on which the arm is taken up as the arm 112 is being moved from the measurement position 118 to the parked position 120. In another embodiment, a first mover is used for moving the arm from the parked position to the measurement position, and a second mover is used for moving the arm from the measurement position to the parked position. These first and second movers can be located, for example, on opposite sides (e.g., upper and lower, or left and right) of the display.

An advantage of the various arm configurations is that they facilitate obtaining repeatability of the position and angle of the sensor at the measurement position. Control of position is desirable to eliminate the variable of position changes with repeated measurements. Control of angle is desirable especially with LCDs. Control of both angle and position is desirable when performing color measurements aimed at restoring the display to a calibrated status; i.e., the “measurement” sensor readings desirably are obtained under the same conditions as when “reference” measurements were obtained. Also, the arm configurations provide close control of the distance of the sensor from the actual surface of the display (screen surface). It is possible, for example, to position the sensor very close to the screen surface without actually contacting the surface, which can be important with sensor devices used with LCDs, for example.

In certain embodiments, upon or after the arm is moved to the measurement location, a measurement cycle and/or calibration-restore routine can be initiated automatically. For example, data concerning the position of the arm is readily obtained from limit switches (one at each of the parked and measurement positions), encoders, or the like. Alternatively, a user can initiate the routine at will or manually as convenient. Automatic initiation of a calibration or measurement routine can be performed during times when the display is not being used, such as late at night, thereby eliminating the need to perform the measurements during busy times.

In the embodiments discussed above, there are various ways in which the measurement information (data produced by the light sensor) may be used. In one example, light of the display sensed by the sensor is automatically used for controlling the wavelength(s), pattern(s), and/or intensity of the light. This control can be achieved using a separate controller (incorporated into the sensor device, incorporated into the display, or as a separate unit) that is configured to interact with the adjustment electronics in the display or to interact with the display driver. For example, an initial set of color and/or intensity readings can be made on a calibrated display, and those values stored (e.g., as a look-up table, or “LUT,” or the like). Later, on a regular timed basis, or on demand, the light sensor is used for obtaining readings as various wavelength(s), pattern(s), and/or intensity(ies) are displayed. Appropriate adjustments to the display driver, based on comparison of the data just obtained by the sensor with the data in the LUT, can be made to restore the wavelength(s), pattern(s), and/or intensity(ies) substantially to the respective calibrated values. The LUT can be located in a computer or the like to which the display is connected or in the display electronics. (More recent LCDs, for example, tend to have LUTs incorporated in them.)

In another example, data from the light sensor are routed to a processor or controller (e.g., in the sensor device or in the display itself) configured to calculate data used for modifying or correcting the data in the look-up table of the display. The respective correction values, or the respective correct values for various calibrations, can be stored, for example, in the controller of the sensor device, the controller of the display, or in the display driver.

As noted above, among various other possible configurations, the light sensor can be a “calorimeter” that includes one or more photodiodes, and optionally colored filters for color discrimination (e.g., R, G, B). The readings can be, but need not be, calibrated to accurate CIE coordinates. Alternatively, they could be simple numbers representing arbitrary values to which the display is restored during calibration using the sensor.

Control of schedules for obtaining color measurements and the particular data obtained by the measurements can reside in a dedicated microprocessor in the sensor device. Alternatively, such control can be achieved by the display's own processor.

The light sensor can include an optical component (e.g., a lens as discussed above) for maximizing the amount of light propagating at a normal angle to the sensor from the display, thereby reducing the effect of light propagating from the display at non-normal angles. Alternatively or in addition to a lens, the optical component can comprise, for example, a tube, a cone, a defined aperture in a plate, feather-weight brushes, shields, or other component that is situated relative to the sensor (e.g., by being mounted to the distal end of the arm). Also, in most embodiments, the arm in the measurement position will provide some blocking of ambient light to the sensor, even in the absence of a tube, cone, aperture, brushes, or the like.

The light sensor can include a multiple-element intensity-to-frequency converter. The signal from such a converter(s) can be input to a microprocessor that detects the frequency or the period of the light from the display, and translates the data to corresponding intensity values.

The light sensor can include one or more color filters used for imparting respective color shifts of respective primary color field(s) of the display, if required or desired. In addition or alternatively, transforms can be used for correcting the color of white light, produced by the display, at different intensity (gray) levels. The values needed by the display for its gamma tables would determine the eventual output of the display. The gamma-table values (in the display or in its driver) can be corrected as needed to restore the color balance of the display to the values recorded by the sensor during a prior calibration of the display.

Alternatively to “calorimeters,” the light sensor can be a device including a graded wavelength interference filter over a multi-element sensor. Another possible sensor configuration is a spectroradiometer using an interference grating and a multi-element sensor. These various configurations are examples; it is contemplated that other light sensors currently in existence and to be developed can be used with equal facility in the subject embodiments of sensor devices.

Many embodiments provide substantial convenience in performing color measurements. First, interconnecting cords are absent or minimized. Second, by integrating the sensor device with the display (or at least mounting the device to the display), there is no possibility of the device being misplaced or adding to clutter in a work area, and even displays that are located in hard-to-reach locations can be readily evaluated and/or calibrated. Third, the light sensor itself is in a safe location on the display, away from most workplace hazards. Fourth, the device can be used by an untrained operator. Fifth, the device is so convenient that it actually will be used, rather than ignored, by busy people.

The invention has been described above in connection with multiple embodiments. However, the invention is not limited to those embodiments. On the contrary, the invention is intended to encompass all modifications, alternatives, and equivalents as may be included within the spirit and scope of the invention, as defined by the appended claims.

What is claimed is:

1. A light-sensor device for a color display, comprising:
an arm having a proximal end and a distal end;
a light sensor situated on the distal end; and
a mover coupled to the proximal end and being configured to move the arm to place the sensor selectively at a parked position and at a measurement position.

2. The device of claim 1, wherein the mover comprises an actuator that is electrically energizable to cause the mover to move the arm.

3. The device of claim 2, wherein the mover comprises a motor.

4. The device of claim 1, wherein:
the display comprises a light-emitting screen; and
the measurement position is at least one predetermined location relative to the screen at which the light sensor receives light from the screen.

5. The device of claim 4, wherein the parked position is a predetermined location at which the light sensor does not receive significant light from the screen.

6. The device of claim 1, wherein:
the display comprises a housing; and
the parked position is in a region of the housing.

7. The device of claim 6, wherein:
the housing comprises a bezel; and
the parked position is along the bezel.

8. The device of claim 6, wherein:
the housing comprises a bezel; and
the parked position is at least partially within the bezel.

9. The device of claim 6, wherein:
the housing comprises a bezel; and
the parked position is on the bezel.

10. The device of claim 1, wherein:
the proximal end of the arm comprises a pivot mounting coupled to the display; and
the mover is configured to pivot the arm about the pivot mounting to place the light sensor selectively at the parked position and at the measurement position.

11. The device of claim 1, wherein the mover is configured to move the arm substantially in one dimension to place the light sensor selectively at the parked position and at the measurement position.

12. The device of claim 11, wherein:
the proximal end of the arm is coupled to a slide; and
the mover is configured to move the proximal end of the arm along the slide.

13. The device of claim 1, wherein the mover is configured to move the arm substantially in at least two dimensions to place the light sensor selectively at the parked position and at the measurement position.

14. The device of claim 13, wherein the mover is configured to move the arm by motions selected from the group consisting of pivoting, rotation, sliding, hinging, elongation, retraction, and combinations thereof.

15. The device of claim 1, wherein the arm is rigid in at least two dimensions.

16. The device of claim 15, wherein the arm is substantially rod-shaped.

17. The device of claim 15, wherein the arm is substantially paddle-shaped.

18. A light-sensor device for a color display, comprising:
an arm having a proximal end and a distal end;
a light sensor situated on the distal end; and
a mounting coupled to the display and configured to couple at least the proximal end of the arm to the display;
wherein the arm is movable relative to the mounting to place the light sensor selectively at a parked position and at a measurement position of the display.

19. The device of claim 18, wherein the arm is flexible in one or two dimensions.

20. The device of claim 18, further comprising a mover situated and configured to move the arm relative to the mounting.

21. The device of claim 20, wherein the mover is electrically energizable.

22. A light-sensor device for a color display, comprising:
arm means;
light-sensor means coupled to a first portion of the arm means; and
mover means, coupled to a second portion of the arm means, for moving at least the first portion and light-sensor means selectively at a parked position and at a measurement position relative to a display.

23. A color display, comprising:
a light-emitting screen; and
a light-sensor device comprising an arm having a proximal end and a distal end, a light sensor situated on the distal end, and a mover coupled to the proximal end, the mover being configured to move the arm to place the sensor selectively at a parked position and at a measurement position relative to the screen.

24. The color display of claim 23, wherein the parked position is a position at which the sensor does not receive significant light from the screen.

25. The color display of claim 23, further comprising a housing, wherein the parked position is adjacent a region of the housing.

26. The color display of claim 23, further comprising a bezel, wherein the parked position is adjacent a region of the bezel.

27. The color display of claim 26, wherein, in the parked position, the arm conforms to a contour of the bezel.

28. The color display of claim 26, wherein, in the parked position, the arm is beneath a portion of the bezel.

29. A method for performing a measurement of a colored light produced by a light-emitting screen of a display, the method comprising:
mounting a light sensor on an arm, the arm being movable relative to the display so as to place the light sensor selectively at a parked position and at a measurement position of the display;
moving the arm to place the sensor at the measurement position;
using the sensor, sensing a color property of light being produced by the screen at the measurement position; and
after sensing the color property, moving the arm to place the sensor at the parked position.
